(19) United States
(12) Patent Application Publication
(10) Pub. No.: US 2007/0070884 A1
(43) Pub. Date: Mar. 29, 2007

(54) Signal transmission method and device

(75) Inventor: Naokatsu Ohkawa, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/316,914

(22) Filed: Dec. 27, 2005

(30) Foreign Application Priority Data
Sep. 26, 2005 (JP) 2005-277080

(51) Int. Cl. H04J 3/14

(52) U.S. Cl. 370/224

(57) ABSTRACT

In a signal transmission method and device which perform squelch processing in order to support a BLSR switchover when a single fault has occurred and when a plurality of faults have occurred over a ring network, NUT information set in a squelch information overhead for a predetermined channel within a channel group over a ring network is extracted; and a NUT table for the predetermined channel is created based on the extracted NUT information. Furthermore, the NUT information is inputted from an outside to be set in the squelch information overhead, and one transmission device transmits a frame including the squelch information overhead to the ring network, and the other transmission device receives the frame from the ring network to be transferred.

### BACKGROUND OF THE INVENTION

1. Field of the Invention

The present invention relates to a signal transmission method and device, and in particular to a signal transmission method and device by which line faults occurring over a ring network are avoided and signals transmitted over the ring network are relieved.

2. Description of the Related Art

As a signal transmission technology for enabling signal relief by avoiding line faults as mentioned above, a BLSR (Bi-directional Line Switched Ring) described hereinafter has been used.

BLSR:

The BLSR is a ring network technology having both of a working bandwidth normally used in a SONET and a protection bandwidth used as a detour path at the time of a line fault occurrence, and has a path switchover function (hereinafter, referred to as BLSR switchover) for the line faults.

Hereinafter, the BLSR switchover will be described referring to FIGS. 12 and 13.

FIGS. 12 and 13 respectively show a ring network configuration where e.g. four transmission devices N1-N4 are connected in a ring form with an optical fiber FB, showing a case where line faults CF1 and CF2 occur between the transmission devices N1 and N4.

In the ring network shown in FIG. 12, a working bandwidth WB and a protection bandwidth PB are allocated for a single optical fiber, and two optical fibers FBI and FB2 respectively for a working system and a protection system are used. This ring network is called 2 Fiber BLSR (hereinafter, referred to as BLSR (2F)).

Also, in the ring network shown in FIG. 13, the working bandwidth WB and the protection bandwidth PB are respectively allocated for two optical fibers, whereby four optical fibers FB1-FB4 are used for the working system and the protection system. This ring network is called 4 Fiber BLSR (hereinafter, referred to as BLSR (4F)).

The BLSR switchovers for relieving signals by avoiding the line faults CF1 and CF2 shown in FIGS. 12 and 13 are called a ring switchover and a span switchover, respectively. Hereinafter, each switchover will be described.

(1) Ring Switchover:

It is supposed that in the ring network configuration using the BLSR (2F) shown in FIG. 12, a SONET signal SS for e.g. a channel 001 is added or inputted from the transmission device N1, and dropped or outputted from the transmission device N3 through the transmission device N4 as shown by a solid line (a).

If in this state the line fault CF1 occurs in the optical fiber FB1 between the transmission devices N1 and N4, both of the working bandwidth WB and the protection bandwidth PB become unavailable. Therefore, the transmission devices N1 and N4 recognize the line fault CF1 to perform a switchover operation as shown in FIG. 12. Accordingly, with regard to the SONET signal SS added from the transmission device N1, “ring switchover” in which a signal goes around the ring network so as to avoid the line fault CF1 through a path of transmission device N1→transmission device N2→transmission device N3→transmission device N4→transmission device N3 as shown by a dotted line (b) is performed for the destination transmission device N3.

(2) Span Switchover:

It is supposed that in the ring network configuration using the BLSR (4F) shown in FIG. 13, the SONET signal SS for e.g. the channel 001 is added or inputted from the transmission device N1, and dropped or outputted from the transmission device N3 through the transmission device N4 as shown by the solid line (a).

When in this state the line fault CF2 occurs in the optical fiber FB1 (working bandwidth) between the transmission devices N1 and N4, the transmission devices N1 and N4 recognize the line fault CF2. However, since the transmission devices N1 and N4 recognize that the optical fiber FB2 (protection bandwidth) is available, with regard to the SONET signal SS added from the transmission device N1, “span switchover”, which switches over the bandwidth so as to avoid the line fault CF2 through a path of transmission device N1→optical fiber FB2 (protection bandwidth)→transmission device N4→optical fiber FB1 (working bandwidth)→transmission device N3 as shown by the dotted line (b), is performed for the destination transmission device N3.

Although not shown in FIG. 13, it is also possible to perform the ring switchover in the ring network configuration using the BLSR (4F) in the same way as the above-mentioned (1).

On the other hand, a recent transmission device can support various kinds of signal forms besides the above-mentioned SONET signal, so that an IP packet or the like can be supported.

Since the IP packet can perform routing per packet, a path over the ring network through which the IP packet is transmitted can be autonomously determined according to traffic or a fault.

IP Packet Routine:

Hereinafter, routing by the IP packet will be described by taking FIG. 14 showing the ring network configuration of FIG. 12, as an example. It is to be noted that the same applies to the ring network configuration of FIG. 13.

As shown by the solid line (a) of FIG. 14, it is supposed that an IP packet IPP for e.g. a channel 002 is added from the transmission device N1, and dropped from the transmission device N3 through the transmission device N4.

When in this state the line fault CF1 occurs in the optical fiber FB1 between the transmission devices N1 and N4, the IP packet IPP is transmitted as shown by the dotted line (b) through a path of transmission device N1→transmission device N2→transmission device N3 autonomously, i.e. in a connectionless basis by avoiding the line fault CF1.

Thus, the IP packet IPP can autonomously perform the routing. Therefore, the BLSR switchovers (1) and (2) operating at the above-mentioned transmission devices are not required. Contrarily, if the BLSR switchover is performed, the IP packet routing is likely to be confused.

Therefore, such needs that signal relief from the line fault should be performed by the BLSR switchover arise for a channel transmitting the SONET signal as shown in FIGS. 12 and 13, while such needs that signal relief from the line fault should be performed by the IP packet routing without using the BLSR switchover arise for a channel transmitting the IP packet as shown in FIG. 14.

The technology realizing the needs is NUT (Non-preemptiable Unprotected Traffic), which can invalidate or disable the BLSR switchover for a predetermined channel over the ring network.

NUT:

In the NUT technology, a NUT table registering NUT information for setting the BLSR switchover valid/invalid for each channel over the ring network is shared between transmission devices, which control validation/invalidation of the BLSR switchover for each channel based on the NUT information set in the NUT table by the transmission devices.

Hereinafter, the NUT table will be described referring to FIG. 15.

FIG. 15 shows an arrangement of the NUT table in which the NUT information for each of the channels 001-192 of e.g. an OC192 optical fiber (hereinafter, this optical fiber is used unless specifically noted) is set.

As for the channels 001, 003, 097, and 099 for example, a ring switchover invalidation is set for the transmission devices N1-N4.

However, in order to share this NUT table between the transmission devices, a user manually performs setting for the transmission devices under present circumstances to create the NUT table.

For this reason, there is a risk that a misconnection is induced due to a setting mistake in the NUT table for a certain transmission device, and a problem that numerous man-hours are required for creating the NUT table.

On the other hand, when a line fault CF3 further occurs between the transmission devices N1 and N2 besides the line fault CF1 between the transmission devices N1 and N4 as shown in FIG. 16 in the ring network configuration using the BLSR (2F) shown in FIG. 12, a signal can not be relieved by the BLSR switchover. If the BLSR switchover is executed in this case, a misconnection may occur in some cases. As shown by the solid line (a), when the line faults CF1 and CF3 occur in a state where the SONET signal SS for the channel 001 is added from the transmission device N1, and dropped or outputted from the transmission device N3 through the transmission device N4 at a normal operation, both of the line faults CF1 and CF3 are detected by the transmission devices N1, N2, and N4. Therefore, as shown by the dotted line (b), the SONET signal SS transmitted from e.g. the transmission device N2 to the transmission device N1 in the channel 001 is looped back by the transmission device N2, so that the looped back SONET signal SS arrives at the transmission device N3 through the transmission device N4 which is also set to loop back.

In order to counter this, each transmission device has a squelching function squelching an add/drop output signal by the device itself.

Squelching Function:

In order to perform such a squelching function, a squelch table shown in FIG. 17 is used.

The squelch table, in which squelch information for each channel over the ring network is set, is for executing “squelching” by which ALL1 is set in signals respectively added and dropped so that the signals are squelched, when the SONET signal SS is set to be added from the transmission device N1 for e.g. the channel 001, and to be dropped from the transmission device N3 through the transmission device N4, as shown in the example of FIG. 16.

Thus, in the above-mentioned ring network, both of the NUT technology and the squelching function are required, so that a technology for executing both of the NUT technology and the squelching function concurrently has already been proposed (see e.g. patent document 1).

Namely, in this patent document 1, as shown in FIG. 18, a squelch table common to transmission devices is created by adding an exclusive use overhead (hereinafter, referred to as squelch information overhead) to a frame and by transmitting the frame between the transmission devices as squelch information. A NUT table common to the transmission devices is concurrently created by further transmitting the NUT table within the ring network by using the squelch information overhead and an additional field.

[Patent Document 1] Japanese Patent Application Laid-open No. 2003-87279

In the above-mentioned patent document 1, a new field (used as a header field in which a NUT type, a relaying direction of a NUT table, a data field address within a frame storing the NUT table and the like are set) is added to the squelch information overhead in order to transmit the NUT table over the ring network. Also, the NUT table itself is stored in the data field within the frame to be transmitted.

In this case, together with an increase of the transmission devices and channels managed over the ring network, the size of the NUT table increases. Therefore, there is a problem that an increase of an information amount to be transmitted oppresses resources within the ring network and causes a processing load in the transmission devices.

### SUMMARY OF THE INVENTION

It is accordingly an object of the present invention to provide a signal transmission method and device performing squelch processing in order to support a BLSR switchover not only when a single fault has occurred over a ring network but also when a plurality of faults have occurred over a ring network, thereby reducing an information amount to be transmitted over the ring network as much as possible.
[1] In order to achieve the above-mentioned object, a signal transmission method (or device) according to the present invention comprises: a first step (or means) of extracting NUT information set in a squelch information overhead for a predetermined channel within a channel group over a ring network; and a second step (or means) of creating a NUT table for the predetermined channel based on the extracted NUT information.

This will now be described by referring to an operation principle of the present invention shown in FIG. 1. The signal transmission method and device according to the present invention are realized in each of the transmission devices N1-N4 over the ring network. For example, in the transmission device N3 where same applies to the transmission devices N1, N2, and N4, at the first step (or means), NUT information included in a squelch information overhead for a predetermined channel received from east direction (E) is extracted.

At the second step (or means), a NUT table for the predetermined channel is created based on the extracted NUT information.

Thus, in the signal transmission method (or device) of the present invention, the NUT information is set by using only the squelch information overhead for the predetermined channel within the channel group over the ring network, thereby enabling the transmission devices to create the NUT table for the predetermined channel based on the NUT information extracted from the squelch information overhead.
[2] The signal transmission method (or device) according to the present invention, in the above-mentioned [1], may further comprise a third step (or means) of inputting the NUT information from an outside to be set in the squelch information overhead and of transmitting a frame including the squelch information overhead to the ring network.

Namely, referring to FIG. 1 in the same way as the above-mentioned [1], for example in the transmission device N2 having received a user request, the NUT table is created by the set NUT information based on the user's request at the third step (or means), and the NUT information is set in the squelch information overhead, so that a frame including the squelch information overhead is transmitted over the ring network.

Thus, the NUT information can be inputted from the outside to be transmitted over the ring network.
[2] The signal transmission method (or device) according to the present invention, in the above-mentioned [2], may further comprise a fourth step (or means) of receiving the frame including the squelch information overhead from the ring network to be transferred.

Namely, referring to FIG. 1, for example in the transmission device N3, the frame including the squelch information overhead in which the NUT information is set is received from the ring network (east direction (E)) at the fourth step (or means), and the frame is transferred to the transmission device N4 located on the west (W) side.

Also, similarly in the transmission devices N4 and N1, the frames including the squelch information overhead in which the NUT information is set are received from the ring network respectively at the fourth step (or means), and the frames are transferred to the transmission devices N1 and N2.

Thus, by sequentially transferring the frames including the squelch information overhead in which the NUT information is set in a relaying direction, the NUT information can be shared between all of the transmission devices N1-N4, each of which can create the same NUT table.
[4] In the above-mentioned [1] of the signal transmission method (or device) according to the present invention, the NUT information may be composed of a source transmission device ID and a destination transmission device ID in the squelch information overhead, and may invalidate a BLSR switchover of the predetermined channel when the source transmission device ID is equal to the destination transmission device ID.

Namely, since identifying information of a source transmission device from which a signal is added and identifying information of a destination transmission device from which a signal is dropped and outputted are required in order to create the squelch table, a format of the squelch information overhead shown in FIG. 18 is always provided with fields for a source transmission device ID and a destination transmission device ID for setting both types of identifying information.

Thus, the NUT information is composed of the source transmission device ID and the destination transmission device ID of the squelch information overhead. Both IDs are set so as to be equal, thereby enabling the BLSR switchover of the predetermined channel to be invalidated.
[5] In the above-mentioned [4] of the signal transmission method (or device) according to the present invention, the NUT information may invalidate a ring switchover of the predetermined channel when the source transmission device ID and the destination transmission device ID are predetermined values.
[6] In the above-mentioned [4] of the signal transmission method (or device) according to the present invention, the NUT information may invalidate a span switchover of the predetermined channel when the source transmission device ID and the destination transmission device ID are predetermined values.
[7] In the above-mentioned [4] of the signal transmission method (or device) according to the present invention, the NUT information may include information for the number of types of combinations based on allocated bit numbers of the source transmission device ID and the destination transmission device ID.

Namely, when allocated bit numbers of the source transmission device ID and the destination transmission device ID for example, are respectively 4 bits, there are 16 combinations (source transmission device ID, destination transmission device ID)=(0, 0), (1, 1), . . . , (15, 15) where the source transmission device ID and the destination transmission device ID are equal, and 16 types of information can be set as NUT information.
[8] In the above-mentioned [4] of the signal transmission method (or device) according to the present invention, the NUT information may be composed of the source transmission device ID and the destination transmission device ID in the squelch information overhead, and the NUT information may compose squelch information when the source transmission device ID is not equal to the destination transmission device ID; the method may further comprise a third step of setting the squelch information in the NUT table corresponding to the predetermined channel.

Namely, while the NUT information is set so that the source transmission device ID becomes equal to the destination transmission device ID in the squelch information overhead in the above-mentioned [4], when the source transmission device ID is not equal to the destination transmission device ID, it is possible to set the squelch information to be formed.

In this case, a transmission device ID of the a transmission device adding therefrom a signal and a transmission device ID of a transmission device dropping therefrom a signal are respectively set in the source transmission device ID and the destination transmission device ID.

At the third step (or device), when the squelch information is received, the squelch information is set in a record within the NUT table corresponding to the predetermined channel based on the squelch information.

It is to be noted that the creation of the squelch table may be performed independently of the creation of the NUT table. Since the squelch information overhead is never used concurrently for both purposes, the squelch information overhead is efficiently used, so that the squelch information or the NUT information is set.

Thus, it is possible to set the squelch information besides the NUT information in the NUT table. For example, when a plurality of line faults occur over the ring network and signal relief can not be performed by the BLSR switchover, the squelch processing can be executed based on the squelch information.
[9] In the above-mentioned [3] of the signal transmission method (or device) according to the present invention, the third step (or means) may include a step (or means) of determining whether or not the NUT information has been transmitted to all transmission devices based on whether or not the NUT information transmitted is equal to NUT information having returned after having gone around the ring network, and of resetting the NUT information in order that the NUT table setting of each transmission device is released to be transmitted, when both types of NUT information are not equal with each other.

Namely, at the third step (or means) of the above-mentioned [2], after the transmission of the NUT information, the NUT information is transmitted to all of the transmission devices over the ring network at the fourth step (or means) of the above-mentioned [3], and return of the NUT information after having gone around the ring network is waited. Whether or not the NUT information transmitted is equal to the NUT information having returned after having gone around the ring network is determined. When both NUT information are not equal with each other it is determined that both NUT information are not properly transmitted, so that the NUT information is reset to release the setting of the NUT table of the transmission devices to be transmitted.

Thus, even when the NUT information is not properly transmitted and different NUT tables are set up in some transmission devices, the NUT information for releasing the NUT table is retransmitted, thereby enabling the equal NUT table to be created between the transmission devices.
[10] In the above-mentioned [3] of the signal transmission method (or device) according to the present invention, the third step (or means) may include a step (or means) of transmitting the NUT information after having been reset in order that the NUT table setting of each transmission device is released when the NUT information has not returned after having gone around the ring network even after a lapse of a predetermined time.

Namely, in the above-mentioned [9], the transmission of the NUT information to all of the transmission devices over the ring network is determined based on whether or not the NUT information transmitted is equal to the NUT information having returned after having gone around the ring network. However, in the present invention [10], when the NUT information has not returned after having gone around the ring network after a lapse of predetermined time, it is determined that the NUT information has not been properly transmitted, so that the NUT information is reset to release the setting of the NUT table of the transmission devices to be transmitted.

Thus, even when the NUT information is not properly transmitted to all of the transmission devices over the ring network, and the NUT table setting in the transmission devices to which the NUT information has been transmitted is different from the NUT table setting in the transmission devices to which no NUT information has been transmitted, it becomes possible to create an equal NUT table between the transmission devices by retransmitting the NUT information for releasing the setting.

According to the present invention, the NUT information can be set by using only the squelch information overhead for a predetermined channel within a channel group over the ring network, and the NUT table can be created for the predetermined channel based on the NUT information extracted from the squelch information overhead by the transmission devices, so that the NUT information can be transmitted with a smaller transmission data amount without using an additional field or a data field for transmitting the NUT information.

Furthermore, even when the transmission device or channel managed over the ring network is increased, the transmission data amount for transmitting the NUT information is fixed, thereby enabling resource oppression within the ring network and a processing load in the transmission devices to be prevented.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an operation principle of a signal transmission method and device according to the present invention;

FIGS. 2A and 2B are flowcharts showing a creating procedure of a NUT table as an embodiment in a signal transmission method and device according to the present invention;

FIG. 3 is a diagram showing a setting example of NUT information and squelch information used in a signal transmission method and device according to the present invention;

FIG. 4 is a diagram showing a creation example (1) of a NUT table (upon span switchover invalidation setting) in a signal transmission method and device according to the present invention;

FIG. 5 is a diagram showing a creation example (2) of a NUT table (upon ring switchover invalidation setting) in a signal transmission method and device according to the present invention;

FIG. 6 is a diagram showing a creation example (3) of a NUT table (upon mixture setting of NUT/squelch information) in a signal transmission method and device according to the present invention;

FIGS. 7A and 7B are flowcharts showing a setting release operation (1) of a NUT table in a signal transmission method and device according to the present invention;

FIG. 8 is a flowchart showing a setting release operation (2) of a NUT table in a signal transmission method and device according to the present invention;

FIG. 9 is a block diagram showing a transmission operation example (1) (upon normal operation) in a signal transmission method and device according to the present invention;

FIG. 10 is a block diagram showing a transmission operation example (2) (when a single fault occurs) in a signal transmission method and device according to the present invention;

FIG. 11 is a block diagram showing a transmission operation example (3) (when a plurality of faults occur) in a signal transmission method and device according to the present invention;

FIG. 12 is a block diagram showing a prior art ring switchover in a ring network;

FIG. 13 is a block diagram showing a prior art span switchover in a ring network;

FIG. 14 is a block diagram showing a prior art IP packet routing in a ring network;

FIG. 15 is a diagram showing a creation example of a prior art NUT table;

FIG. 16 is a block diagram showing prior art squelch processing;

FIG. 17 is a diagram showing a creation example of prior art squelch information; and

FIG. 18 is a diagram showing a format of a squelch information overhead used for both of the present invention and the prior art invention.

### DESCRIPTION OF THE EMBODIMENTS

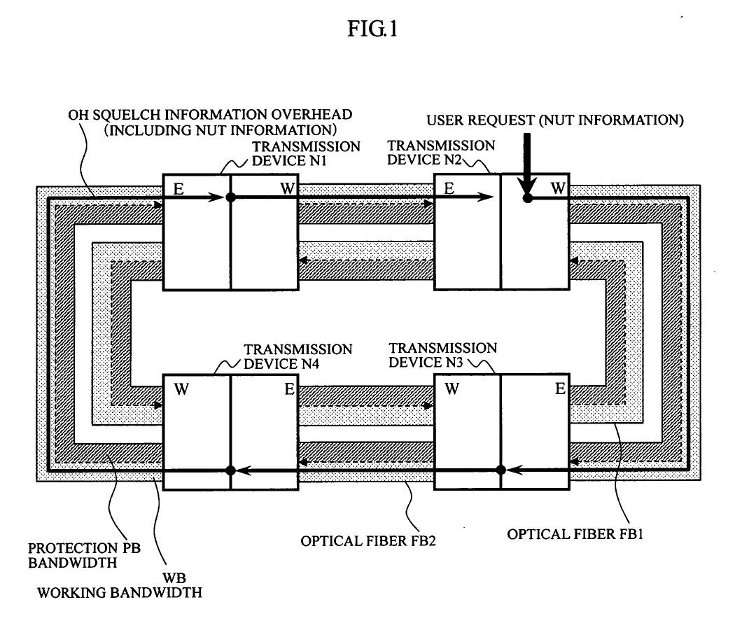

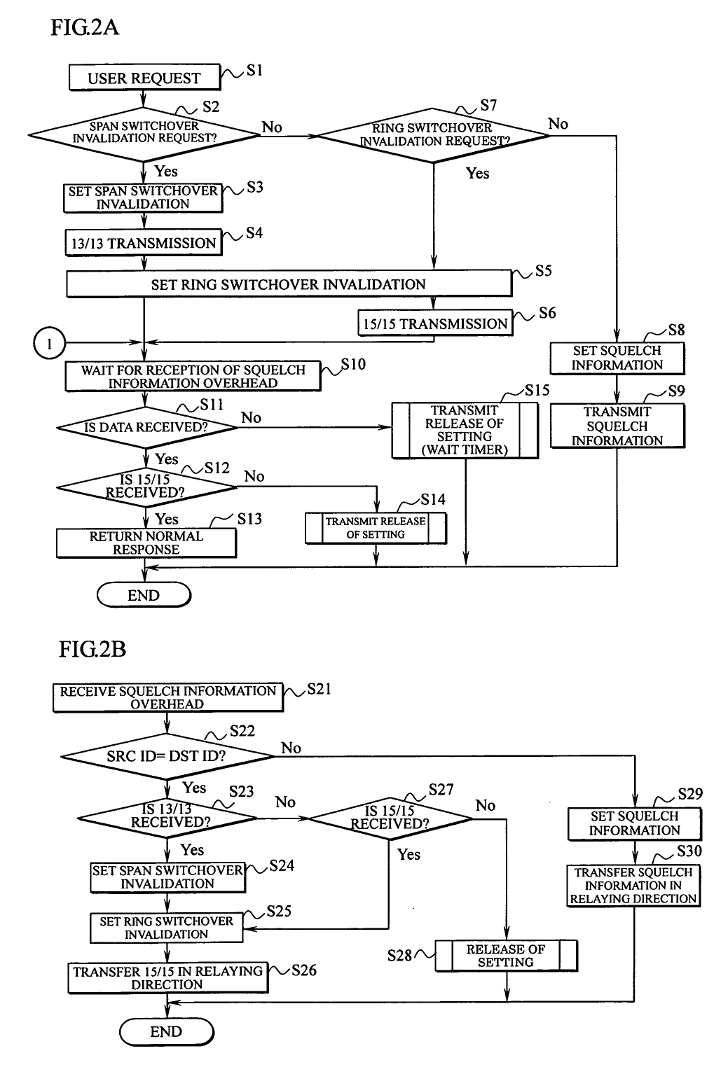

The signal transmission method and device according to the present invention are realized in the transmission devices N1-N4 as described referring to FIG. 1. In one embodiment, a procedure example of the NUT table creation, the arrangement of the NUT table, an operation example of the NUT table setting release, and an operation example of the signal transmission based on the NUT table set up will now be described referring to FIGS. 2A, 2B, 3-6, 7A, 7B, and 8-11.

NUT Table Creation Procedure/arrangement: FIGS. 2A, 2B, and 3-6

Firstly, a squelch information overhead-source transmission device shown in FIG. 2A corresponds to e.g. the transmission device N2 in the ring network configuration shown in FIG. 1, which indicates a transmission device creating the NUT table based on the user request inputted from the outside, i.e. the NUT information and setting the NUT information in the squelch information overhead to be transmitted over the ring network.

Also, a squelch information overhead-receiving transmission device shown in FIG. 2B corresponds to e.g. the transmission devices N1, N3, and N4 in the ring network configuration shown in FIG. 1, which indicates a transmission device receiving the squelch information overhead in which the NUT information is set from the ring network, creating the NUT table based on the extracted NUT information, and transferring the received squelch information overhead. It is supposed that FIGS. 2A and 2B respectively indicate the transmission devices N2 and N3 as an example in the following description.

Hereinafter, the procedure example of the NUT table creation and the arrangement of the NUT table created by the procedure in a case where the span switchover or the ring switchover is set invalid or disable for a predetermined channel or in a case where squelch information is set will be described referring to FIGS. 2A, 2B, and 3-6.

[1] NUT Table Creation Procedure in the Squelch Information Overhead-source Transmission Device: FIG. 2A

(1) Span Switchover Invalidation Setting:

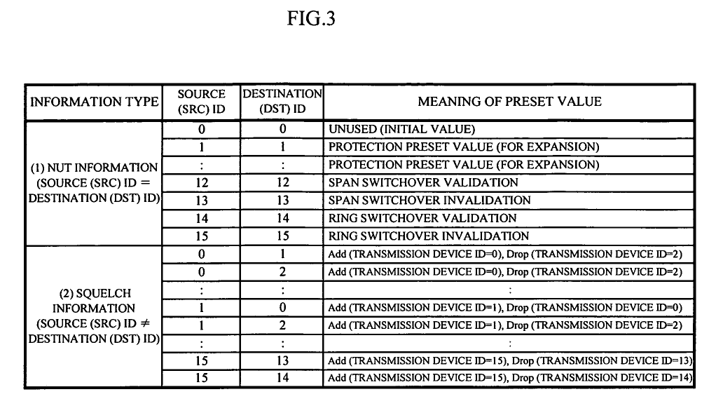

In the ring network of FIG. 1, when the squelch information overhead-source transmission device N2 receives a request from a user (at step S1), the transmission device N2 determines whether or not the request (NUT information shown in (1) of FIG. 3) is for setting the span switchover invalid (at step S2). If it is a request for the span switchover invalidation, a record corresponding to the device itself (transmission device N2 in this example) within the NUT table is set to span switchover invalidation (at step S3).

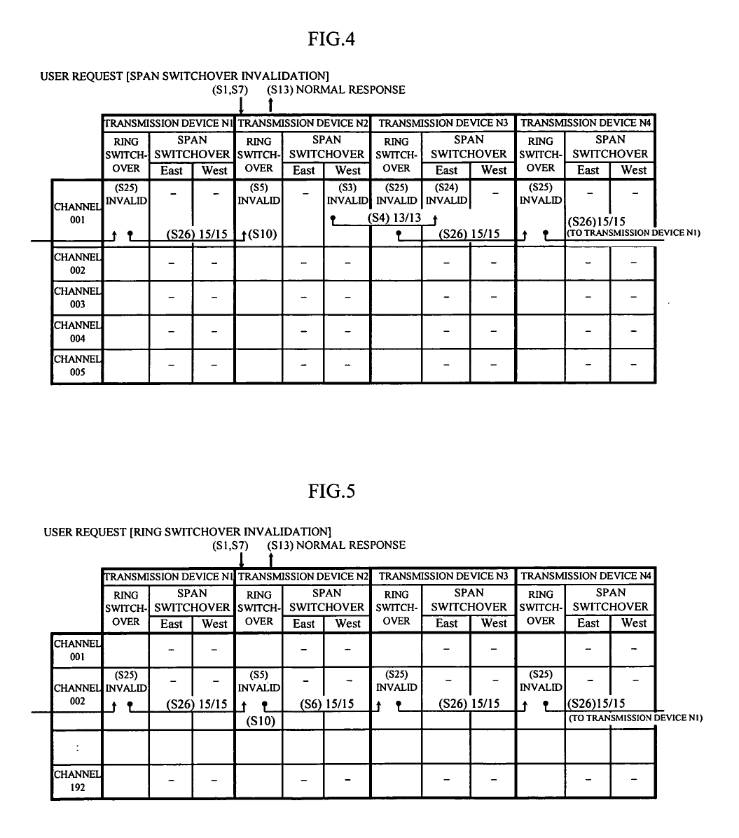

FIG. 4 shows the NUT table arrangement set up at step S3. This NUT table arrangement indicates a case where the span switchover invalidation is set for the channel 001 in a section between the west (W) side of the transmission device N2 and the east (E) side of the transmission device N3 in the ring network configuration shown in FIG. 1. It is to be noted that steps S1-S26 shown in FIG. 4 respectively correspond to steps S1-S26 shown in FIGS. 2A and 2B.

For the other transmission devices N3, N4, and N1, as shown in the NUT information setting (1) of FIG. 3, the span switchover invalidation setting is executed by setting “13” respectively in the source transmission device (SRC) ID of squelch information overhead and the destination transmission device (DST) ID of the squelch information overhead (hereinafter, simply referred to as “13/13”). Therefore, the transmission device N2 transmits NUT information “13/13” in the relaying direction of the transmission device N3 (at step S4).

On the other hand, the setting of the span switchover invalidation may be performed to not all of the ring network but only to a specified section, namely e.g. the section between the transmission devices N2 and N3 in the ring network configuration shown in FIG. 1. However, since it means that the specified section can not be used even for the ring switchover, the ring switchover invalidation has to be set for the channel where the span switchover invalidation is set, in a section with respect to the transmission device N3.

Therefore, the ring switchover invalidation is also set in the record corresponding to the device itself within the NUT table as shown in FIG. 4 (at step S5).

Hereafter, the transmission device N2 enters a waiting operation of the NUT information go-around (at steps S10-S15), which will be described later.

(2) Ring Switchover Invalidation Setting:

The squelch information overhead-source transmission device N2 receives the request (NUT information shown in (1) of FIG. 3) for setting the ring switchover invalid from the user (at step S1), proceeds to step S7 through step S2, and proceeds to step S5 by determining that the request is for the ring switchover invalidation.

At step S5, the ring switchover invalidation is set in the record corresponding to the device itself within the NUT table.

The ring switchover invalidation setting between the transmission devices N1 and N2, N3 and N4, and N4 and N1 is executed by setting “15” respectively in the source transmission device (SRC) ID and the destination transmission device (DST) ID of the squelch information overhead as shown in (1) of FIG. 3 (hereinafter, simply referred to as “15/15”). Therefore, the transmission device N2 transmits NUT information “15/15” in the relaying direction of the transmission device N3 (at step S6).

FIG. 5 shows the NUT table in this case. This example indicates a case where the ring switchover between the transmission devices for the channel 002 is set invalid in the ring network configuration shown in FIG. 1. It is to be noted that steps S1-S26 shown in FIG. 5 respectively correspond to steps S1-S26 shown in FIG. 2.

Hereafter, the transmission device N2 enters a waiting operation of the NUT information go-around (at steps S10-S15).

As mentioned above, the NUT information for setting the span switchover and/or the ring switchover invalid is transmitted by using only the squelch information overhead for a predetermined channel within a channel group over the ring network, thereby enabling the transmission devices to create the NUT table based on the NUT information respectively.

(3) Squelch Information Setting:

The squelch information overhead-source transmission device N2 receives a request (squelch information shown in (2) of FIG. 3) for setting the squelch information from a user (at step S1), and proceeds to step S8 through steps S2 and S7.

At this step S8, the squelch information is set in the record corresponding to the device itself within the NUT table.

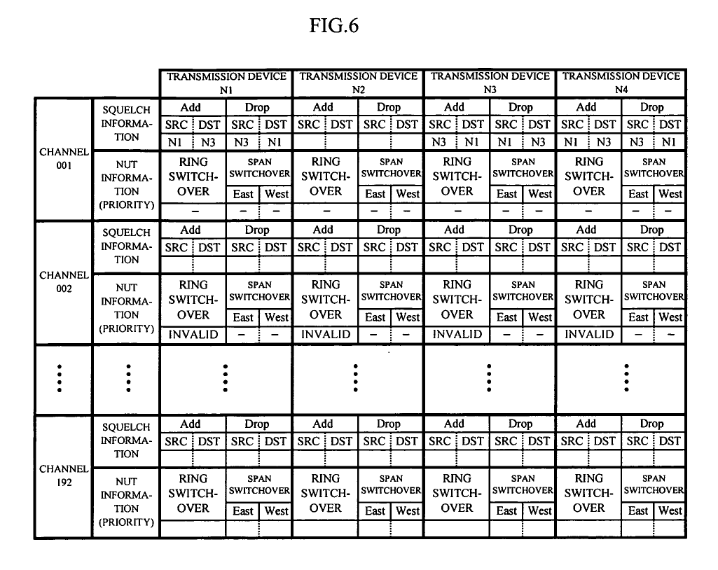

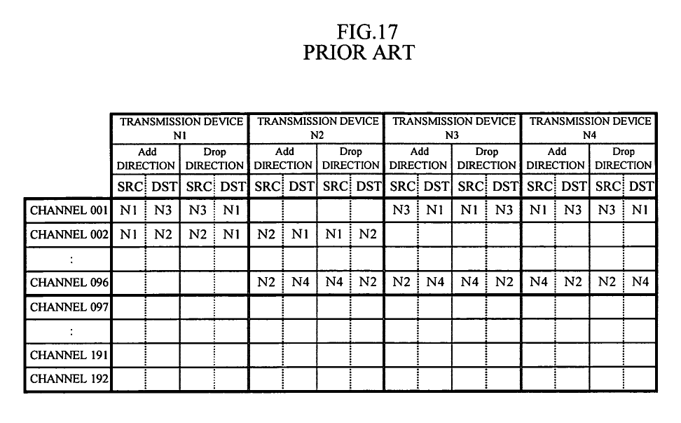

FIG. 6 shows the NUT table in this case, where the squelch information for the channel 001 is further set besides the above-mentioned NUT table (see FIG. 4) created by the span switchover invalidation setting and the NUT table (see FIG. 5) created by the ring switchover invalidation setting. The set squelch information is used to perform the same setting as the channel 001 of the squelch table shown in FIG. 17, where the span switchover invalidation setting is omitted for simplifying the figure.

It is to be noted that the squelch information is added to the NUT table after having created the NUT table in the above description. To the contrary, the NUT information may be added to the squelch table after having created the squelch table.

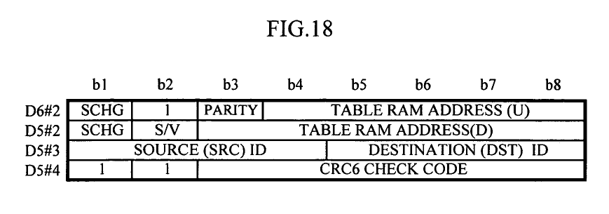

Hereafter, as shown in the squelch information (2) of FIG. 3, the transmission device ID for adding the signal and the transmission device ID for dropping the signal are respectively set to the source transmission device (SRC) ID and the destination transmission device (DST) ID of the squelch information overhead (see FIG. 18) to be transmitted to the transmission device located in the relaying direction (at step S9). The source transmission device (SRC) ID and the destination transmission device (DST) ID may be any value so long as they are different from each other.

[2] NUT Table Creating Procedure in Squelch Information Overhead-receiving Transmission Device: FIG. 2B

(1) Span Switchover Invalidation Setting:

The squelch information overhead-receiving transmission device N3 receives the squelch information overhead from the ring network (at step S21) to determine whether or not the source transmission device ID of the squelch information overhead received is equal to the destination transmission device ID (at step S22). When both IDs are equal with each other, it is determined that the information is the NUT information. When the ID of both transmission devices is “13/13”, it is determined that the NUT information indicates the span switchover invalidation (at step S23), so that the span switchover invalidation is set in the record corresponding to the device itself within the NUT table (at step S24). This span switchover invalidation setting creates the NUT table as shown in FIG. 4, in the same way as the above-mentioned step S3.

Thus, the span switchover invalidation setting in the NUT table, i.e. the setting of the NUT table corresponding to the transmission devices (e.g. transmission devices N2 and N3 in the ring network configuration shown in FIG. 1) in the specific section over the ring network is completed. However, since the channel in which the span switchover invalidation is set has to be also set to the ring switchover invalidation in all of the transmission devices, the ring switchover invalidation is also set in the record corresponding to the device itself within the NUT table in the same way as the above-mentioned step S5 (at step S25).

According to the NUT information setting shown in (1) of FIG. 3, the NUT information “15/15” indicating the ring switchover invalidation is set in the squelch information overhead, and is transferred to the transmission device located in the relaying direction (at step S26).

(2) Ring Switchover Invalidation Setting:

On the other hand, the transmission device N3 having received the squelch information overhead transferred (at step S21) determines that the information is the NUT information when the source transmission device ID of the squelch information overhead received is equal to the destination transmission device ID (at step S22), and further determines that the information is the NUT information indicating the ring switchover invalidation when the ID of both transmission devices is also “15/15” (at steps S23 and S27).

It is to be noted that when the ID of both transmission devices is not “15/15”, a release of setting is executed, which will be described later (at step S28).

In the same way as step S5 of FIG. 2, the ring switchover invalidation is set in the record corresponding to the device itself within the NUT table (at step S25), and the squelch information overhead received is further transferred to the transmission device located in the relaying direction (at step S26).

(3) Squelch Information Setting:

The squelch information overhead-receiving transmission device N3 receives the squelch information overhead from the ring network (at step S21), to determine that the information is the squelch information (at step S22) when the source transmission device ID of the squelch information overhead received is not equal to the destination transmission device ID, and to set the squelch information in the record corresponding to the device itself within the NUT table in the same way as the above-mentioned step S8 (at step S29). The squelch information overhead received is further transferred to the transmission device located in the relaying direction (at step S30). This transfer operation can be performed in the same way as the above-mentioned step S9.

[3] Waiting Operation of NUT Information Go-around: Steps S10-S12

The squelch information overhead-source transmission device N2 waits for the return of the squelch information overhead including the NUT information transmitted at step S6 after having gone around all of the transmission devices over the ring network (at step S10).

When the squelch information overhead is received (at step S11), it is determined (at step S12) whether or not the NUT information is properly transmitted and the ring switchover invalidation is set in the NUT tables in all of the transmission devices, namely the returned NUT information is “15/15”. As a result, if it is determined that the NUT information is properly transmitted, a normal response for the user request is returned (at step S13).

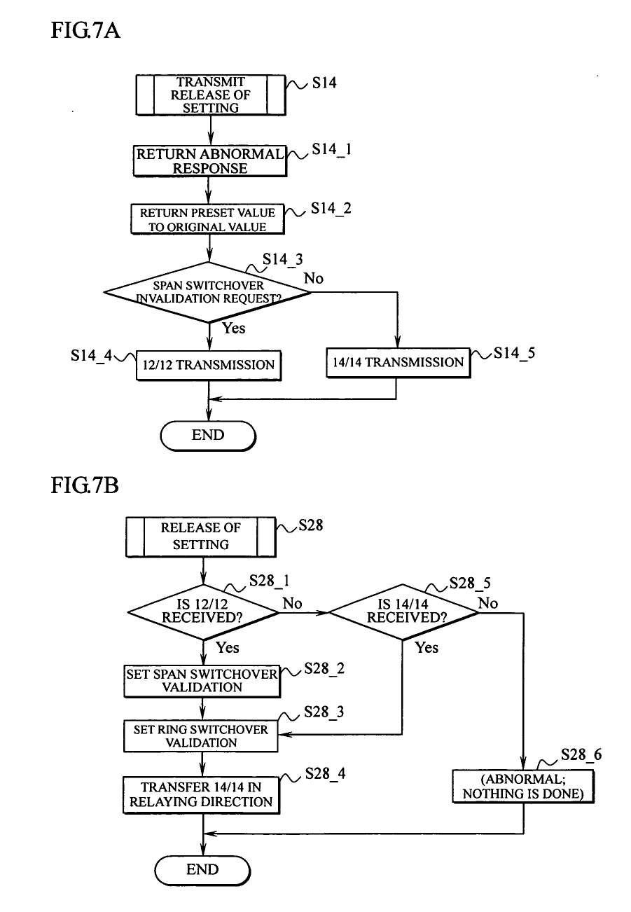

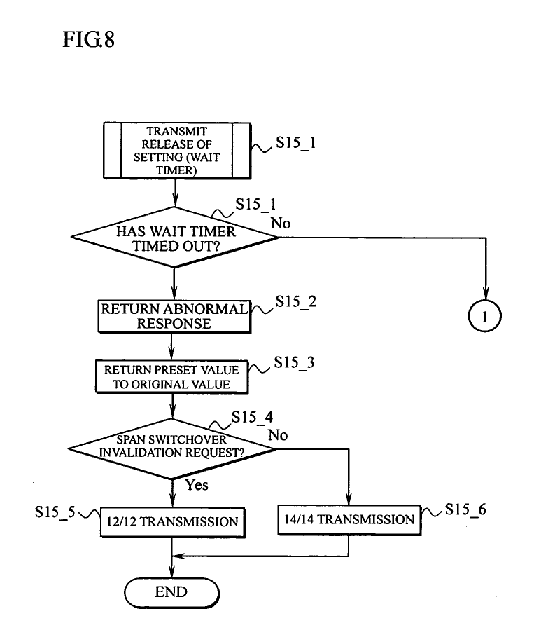

There will be described later a transmission for release of setting (at step S14) executed when the NUT information is not properly transmitted, and a transmission for release of setting (at step S15) executed when the squelch information overhead can not be received for a fixed time at step S11.

[4] Release Operation of NUT Table Setting: FIGS. 7A, 7B, and 8

Hereinafter, the release operation of the NUT table setting in the squelch information overhead-source transmission device and the receiving transmission device when the NUT information is transmitted to all of the transmission devices but the NUT information is not transmitted as proper NUT information will be described respectively.

(1) Release Operation of Setting at Step S14 (See FIG. 7A) in FIG. 2A:

When the NUT information is not properly transmitted in the squelch information overhead-source transmission device N2, an abnormal response for the user request is returned (at step S14_1), and a preset value of the record corresponding to the device itself within the NUT table is returned to an original value (at step S14_2).

When the squelch information overhead-source transmission device N2 has failed in the invalidation setting of the span switchover, according to the NUT information setting (1) of FIG. 3, “12” is set respectively in the source transmission device (SRC) ID and the destination transmission device (DST) ID of the squelch information overhead in order to indicate the span switchover validation (hereinafter, simply referred to as “12/12”) to be transmitted to the transmission device N3 located in the relaying direction (at steps S14_3 and S14_4).

On the other hand, when the squelch information overhead-source transmission device N2 has failed in the invalidation setting of the ring switchover, “14” is similarly set for the source transmission device (SRC) ID and the destination transmission device (DST) ID of the squelch information overhead respectively in order to indicate the ring switchover validation (hereinafter, simply referred to as “14/14”) to be transmitted to the transmission device N3 located in the relaying direction (at steps S14_{—3} and S14_{—5}).

(2) Release Operation of Setting at Step S15 (See FIG. 8) in FIG. 2A:

When the NUT information has not returned after a lapse of a predetermined time (at step S15_{—1}), the same release of setting as the above-mentioned release operation (1) of NUT table setting (at steps S14_{—1}-S14_{—5}) is performed (at steps S15_{—2}-S15_{—7}).

On the other hand, within a predetermined time interval, the transmission device transitions to a reception waiting state of the squelch information overhead again, i.e. step S9 in FIG. 2A.

(3) Release Operation of Setting at Step S28 (See FIG. 7B) in FIG. 2B:

When the NUT information set in the received squelch information overhead is the span switchover validation “12/12” (at step S28_{—1}), the preset value of the record corresponding to the device itself within the NUT table is returned to the original value (span switchover validation and ring switchover validation) (at steps S28_{—2} and S28_{—3}), so that the ring switchover validation “14/14” is set in the squelch information overhead to be transferred to the transmission device located in the relaying direction (at step S28_{—4}).

On the other hand, when the NUT information received is the ring switchover validation “14/14” (at step S28_{—5}), the preset value of the record corresponding to the transmission device itself within the NUT table is returned to the original value (ring switchover validation) (at steps S28_{—2} and S28_{—3}), and the squelch information overhead is further transferred to the transmission device located in the relaying direction (at step S28_{—4}).

Also, when the NUT information received is neither the span switchover validation nor the ring switchover validation, it is regarded as abnormal where nothing is done (at step S28_{—6}).

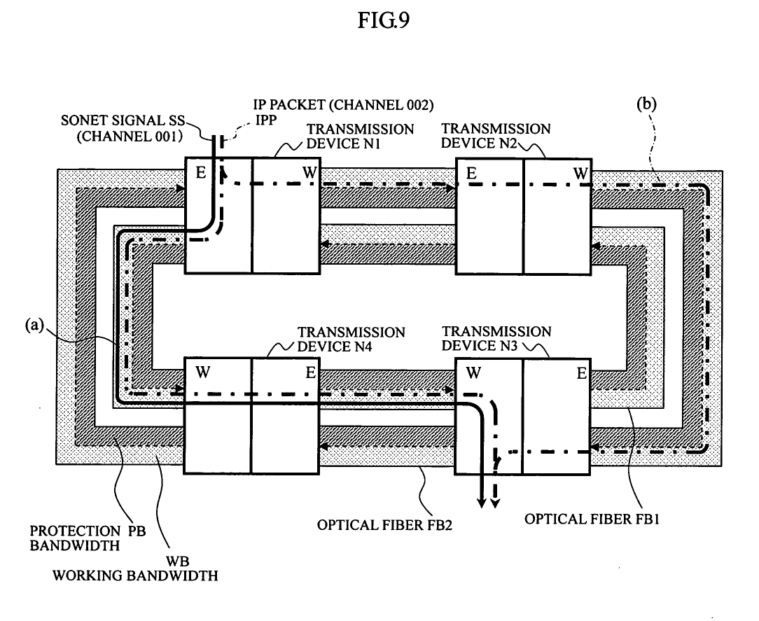

As described above, even when the NUT information is not properly transmitted to all of the transmission devices, so that the NUT table setting is different in some transmission devices, it is possible to release the different NUT table setting and to return the setting to the same NUT table setting in the transmission devices.

[5] Signal Transmission Operation Example: FIGS. 9-11

Hereinafter, a signal transmission operation example based on the setting of the NUT table created as mentioned above will be described referring to FIGS. 9-11. In the following description, it is supposed that the NUT table shown in FIG. 6 is used.

(1) Signal Transmission Operation Example Upon Normal Operation: FIG. 9

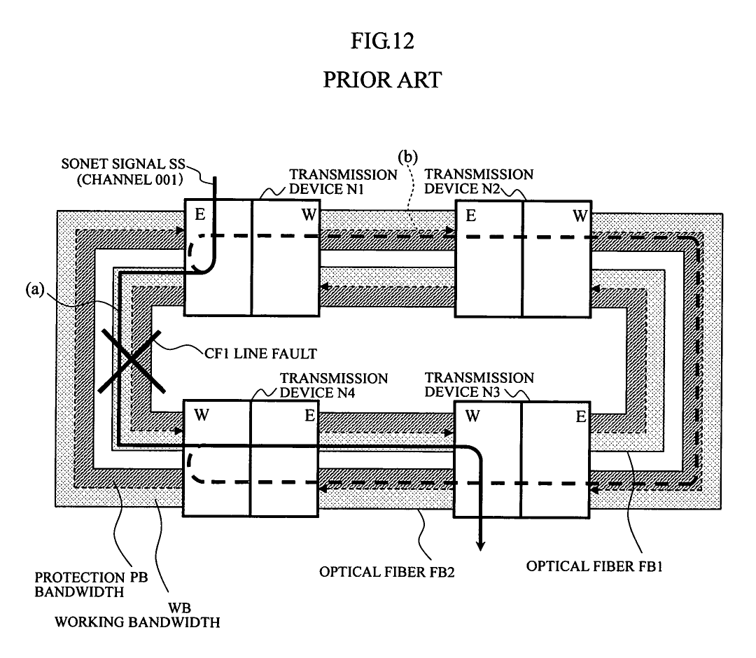

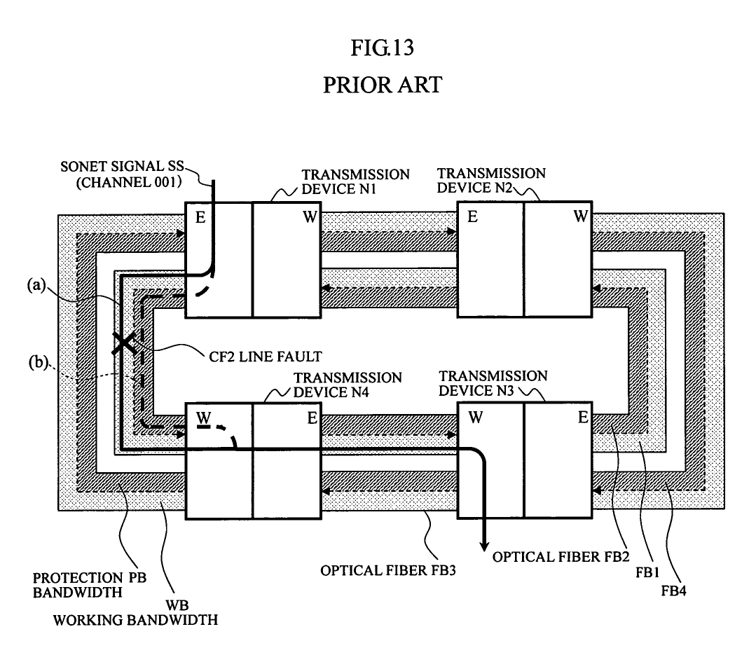

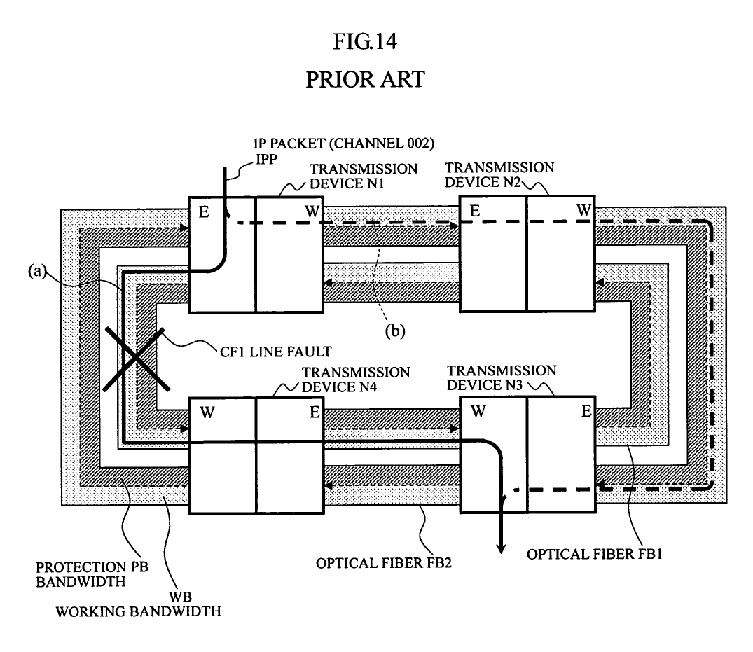

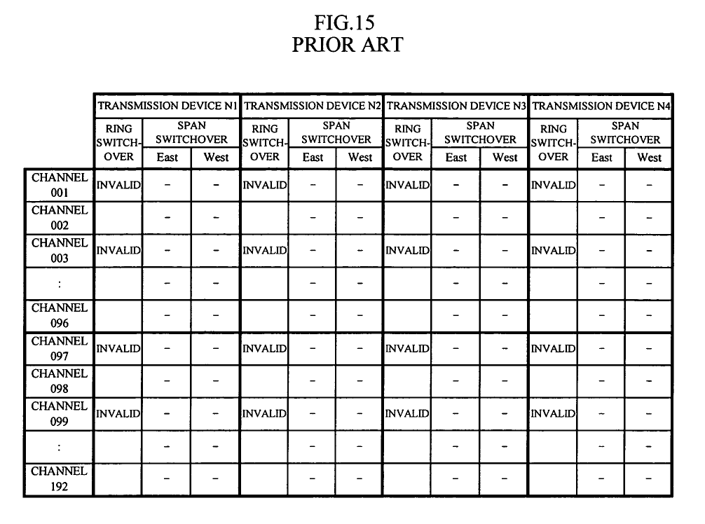

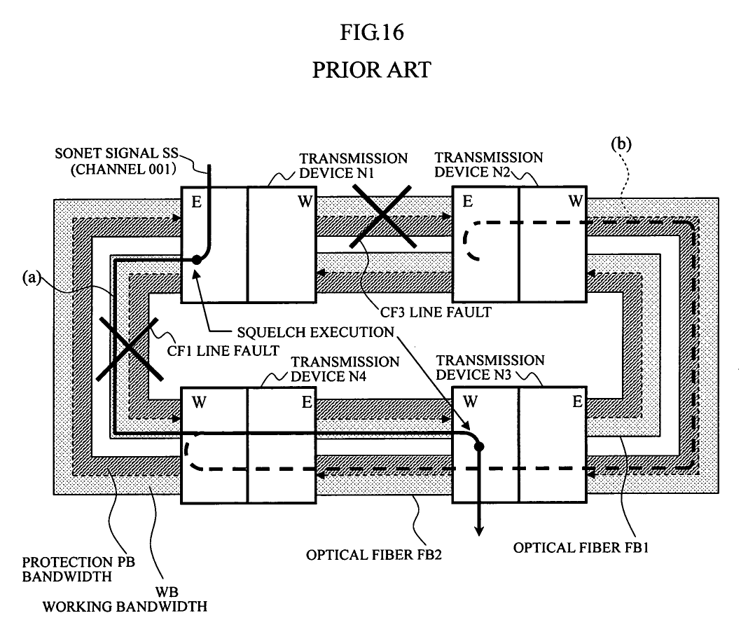

FIG. 9 shows a case where the SONET signal SS for the channel 001 is added from the transmission device N1 in the ring network configuration using the BLSR (2F) shown in FIG. 12, and is dropped from the transmission device N3 through the transmission device N4 as shown by the solid line (a), while at the same time the IP packet IPP for the channel 002 is added from the transmission device N1, and is dropped from the transmission device N3 by autonomously determining either through the transmission device N4 or N2 as shown by the long and short dashed line (b).

Since no line fault has occurred, it is obvious that the BLSR switchover is not performed and the setting of the NUT table has nothing to do with the signal transmission.

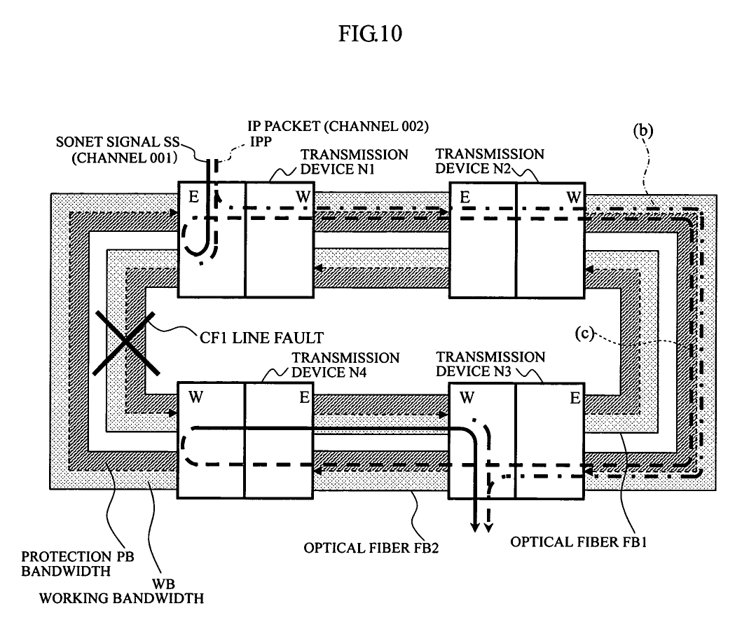

(2) Signal Transmission Operation Example in a Case Where a Single Fault Occurs: FIG. 10

FIG. 10 shows a case where the line fault CF1 occurs in the optical fiber FB1 in the transmission devices N1-N4 in the ring network configuration shown in FIG. 9.

When the line fault CF1 occurs, both of the working bandwidth WB and the protection bandwidth PB become unavailable. Therefore, the transmission devices N1 and N4 recognize the line fault CF1, and perform signal relief based on the NUT information of the NUT table.

Since the BLSR switchover is set valid in the NUT information for the channel 001 in the NUT table shown in FIG. 6, the ring switchover is executed so that the SONET signal SS is transmitted through the transmission device N1→transmission device N2→transmission device N3→transmission device N4→transmission device N3 as shown by the dotted line (c) of FIG. 10.

Also, since the ring switchover is set invalid in the NUT information for the channel 002 of the NUT table shown in FIG. 6, the ring switchover is not performed.

Accordingly, the IP packet IPP is not confused by the BLSR switchover as shown by the long and short dashed line (b) of FIG. 10, and is transmitted through the path autonomously determined of the transmission device N1→transmission device N2→transmission device N3.

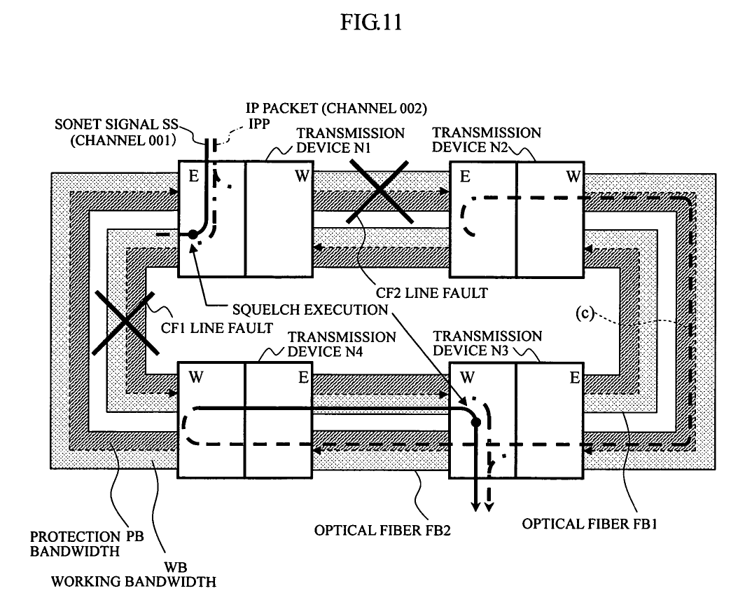

(3) Signal Transmission Operation Example in a Case Where a Plurality of Faults Occur: FIG. 11

FIG. 11 shows a case where the line fault CF2 further occurs in the optical fiber FB2 between the transmission devices N1 and N2 in the ring network configuration shown in FIG. 10.

In this case, the signal relief by the BLSR switchover can not be performed. However, since the squelch information for the channel 001 in the NUT table shown in FIG. 6 is set, the transmission devices N1 and N3 perform the squelch processing based on the squelch information set in the NUT table and can respectively squelch signals added and dropped with “ALL1” signal, even in a case where the SONET signal SS is looped back at the transmission devices N2 and N4, and arrives at the transmission device N3 as shown by the dotted line (c) of FIG. 11.

Also, since the ring switchover is set invalid in the NUT information for the channel 002 of the NUT table shown in FIG. 6, the BLSR switchover is not performed.

Accordingly, the IP packet IPP is not confused by the BLSR switchover, so that the transmission is autonomously stopped.

It is to be noted that the present invention is not limited by the above-mentioned embodiments, and it is obvious that various modifications may be made by one skilled in the art based on the recitation of the claims.

What is claimed is:

1. A signal transmission method comprising:
a first step of extracting NUT information set in a squelch information overhead for a predetermined channel within a channel group over a ring network; and
a second step of creating a NUT table for the predetermined channel based on the extracted NUT information.

2. The signal transmission method as claimed in claim 1, further comprising a third step of inputting the NUT information from an outside to be set in the squelch information overhead and of transmitting a frame including the squelch information overhead to the ring network.

3. The signal transmission method as claimed in claim 2, further comprising a fourth step of receiving the frame including the squelch information overhead from the ring network to be transferred.

4. The signal transmission method as claimed in claim 1, wherein the NUT information is composed of a source transmission device ID and a destination transmission device ID in the squelch information overhead, and invalidates a BLSR switchover of the predetermined channel when the source transmission device ID is equal to the destination transmission device ID.

5. The signal transmission method as claimed in claim 4, wherein the NUT information invalidates a ring switchover of the predetermined channel when the source transmission device ID and the destination transmission device ID are predetermined values.

6. The signal transmission method as claimed in claim 4, wherein the NUT information invalidates a span switchover of the predetermined channel when the source transmission device ID and the destination transmission device ID are predetermined values.

7. The signal transmission method as claimed in claim 4, wherein the NUT information includes information for the number of types of combinations based on allocated bit numbers of the source transmission device ID and the destination transmission device ID.

8. The signal transmission method as claimed in claim 4, wherein the NUT information is composed of the source transmission device ID and the destination transmission device ID in the squelch information overhead, and the NUT information composes squelch information when the source transmission device ID is not equal to the destination transmission device ID; the method further comprising a third step of setting the squelch information in the NUT table corresponding to the predetermined channel.

9. The signal transmission method as claimed in claim 3, wherein the third step includes a step of determining whether or not the NUT information has been transmitted to all transmission devices based on whether or not the NUT information transmitted is equal to NUT information having returned after having gone around the ring network, and of resetting the NUT information in order that the NUT table setting of each transmission device is released to be transmitted, when both types of NUT information are not equal with each other.

10. The signal transmission method as claimed in claim 3, wherein the third step includes a step of transmitting the NUT information after having been reset in order that the NUT table setting of each transmission device is released when the NUT information has not returned after having gone around the ring network even after a lapse of a predetermined time.

11. A signal transmission device comprising:
a first means extracting NUT information set in a squelch information overhead for a predetermined channel within a channel group over a ring network; and
a second means creating a NUT table for the predetermined channel based on the extracted NUT information.

12. The signal transmission device as claimed in claim 11, further comprising a third means inputting the NUT information from an outside to be set in the squelch information overhead and of transmitting a frame including the squelch information overhead to the ring network.

13. The signal transmission device as claimed in claim 12, further comprising a fourth means receiving the frame including the squelch information overhead from the ring network to be transferred.

14. The signal transmission device as claimed in claim 11, wherein the NUT information is composed of a source transmission device ID and a destination transmission device ID in the squelch information overhead, and invalidates a BLSR switchover of the predetermined channel when the source transmission device ID is equal to the destination transmission device ID.

15. The signal transmission device as claimed in claim 14, wherein the NUT information invalidates a ring switchover of the predetermined channel when the source transmission device ID and the destination transmission device ID are predetermined values.

16. The signal transmission device as claimed in claim 14, wherein the NUT information invalidates a span switchover of the predetermined channel when the source transmission device ID and the destination transmission device ID are predetermined values.

17. The signal transmission device as claimed in claim 14, wherein the NUT information includes information for the number of types of combinations based on allocated bit numbers of the source transmission device ID and the destination transmission device ID.

18. The signal transmission device as claimed in claim 14, wherein the NUT information is composed of the source transmission device ID and the destination transmission device ID in the squelch information overhead, and the NUT information composes squelch information when the source transmission device ID is not equal to the destination transmission device ID; the device further comprising a third means setting the squelch information in the NUT table corresponding to the predetermined channel.

19. The signal transmission device as claimed in claim 13, wherein the third means includes a means determining whether or not the NUT information has been transmitted to all transmission devices based on whether or not the NUT information transmitted is equal to NUT information having returned after having gone around the ring network, and of resetting the NUT information in order that the NUT table setting of each transmission device is released to be transmitted, when both types of NUT information are not equal with each other.

20. The signal transmission device as claimed in claim 13, wherein the third means includes a means transmitting the NUT information after having been reset in order that the NUT table setting of each transmission device is released when the NUT information has not returned after having gone around the ring network even after a lapse of a predetermined time.
